(19) United States
(12) Patent Application Publication
(10) Pub. No.: US 2019/0068342 A1
(43) Pub. Date: Feb. 28, 2019

(54) COMMUNICATION EFFICIENCY

(71) Applicant: NOKIA SOLUTIONS AND NETWORKS OY, Espoo (FI)

(72) Inventor: Ajith KUMAR PARAMESWARN RAJAMMA, TamilNadu (IN)

(21) Appl. No.: 16/073,251

(22) PCT Filed: Nov. 17, 2016
(86) PCT No.: PCT/EP2016/078031

§ 371 Date: Jul. 27, 2018

(30) Foreign Application Priority Data
Jan. 29, 2016 (IN) 201641003292

(51) Int. Cl. H04L 5/00; H04W 72/08; H04W 52/38; H04W 72/04

(52) U.S. Cl. CPC H04L 5/0048; H04W 72/044; H04W 52/383; H04W 72/085

(57) ABSTRACT

There is provided a method comprising: determining, by a first terminal device of a radio communication network, a need to transmit first data to a second terminal device of the radio communication network and second data to another receiver of the radio communication network; acquiring, from a network node of the radio communication network, radio resources for transmitting the first and the second data; and performing a non-orthogonal transmission of the first and second data substantially simultaneously on the same frequency based on the acquired radio resources.

### TECHNICAL FIELD

The invention relates to communications.

### BACKGROUND

In a communication network, data may be transmitted between a plurality devices, such as terminal devices and network nodes. As the number of devices in a network increases, more may also be required from the network and from techniques used for the data transmission. Therefore, it may be beneficial to provide data transmission solutions which, for example, decrease overall network load.

### BRIEF DESCRIPTION

According to an aspect, there is provided the subject matter of the independent claims. Some embodiments are defined in the dependent claims.

One or more examples of implementations are set forth in more detail in the accompanying drawings and the description below. Other features will be apparent from the description and drawings, and from the claims.

### BRIEF DESCRIPTION OF DRAWINGS

In the following embodiments will be described in greater detail with reference to the attached drawings, in which

FIG. 1 illustrates an example a cellular communication system to which embodiments of the invention may be applied;

FIGS. 2 to 3 illustrate flow diagrams according to some embodiments;

FIGS. 4A to 4D illustrate some embodiments;

FIGS. 5A to 5C illustrate some embodiments;

FIGS. 6A to 6B illustrate some embodiments;

FIG. 7 illustrates a flow diagram according to an embodiment; and

FIGS. 8 to 9 illustrate block diagrams according to some embodiments.

### DETAILED DESCRIPTION OF SOME EMBODIMENTS

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

Embodiments described may be implemented in a radio system, such as in at least one of the following: Worldwide Interoperability for Micro-wave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), Long Term Evolution (LTE), and/or LTE-Advanced.

The embodiments are not, however, restricted to the system given as an example but a person skilled in the art may apply the solution to other communication systems provided with necessary properties. Another example of a suitable communications system is the 5G concept. 5G is likely to use multiple input-multiple output (MIMO) techniques (including MIMO antennas), many more base stations or nodes than the LTE (a so-called small cell concept), including macro sites operating in co-operation with smaller stations and perhaps also employing a variety of radio technologies for better coverage and enhanced data rates. 5G will likely be comprised of more than one radio access technology (RAT), each optimized for certain use cases and/or spectrum. 5G mobile communications will have a wider range of use cases and related applications including video streaming, augmented reality, different ways of data sharing and various forms of machine type applications, including vehicular safety, different sensors and real-time control. 5G is expected to have multiple radio interfaces, namely below 6 GHz, cmWave and mmWave, and also being integradable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility. It should be appreciated that future networks will most probably utilize network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or cloud data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labor between core network operations and base station operations may differ from that of the LTE or even be non-existent. Some other technology advancements probably to be used are Software-Defined Networking (SDN), Big Data, and all-IP, which may change the way networks are being constructed and managed.

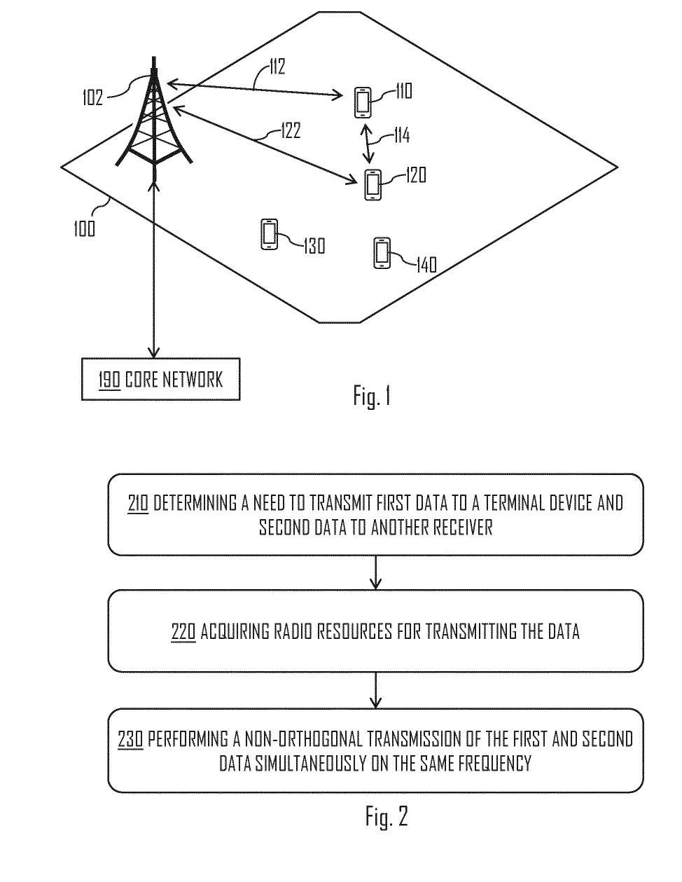

FIG. 1 illustrates an example of a cellular communication system (also referred to as a radio communication system) to which some embodiments may be applied. Cellular radio communication networks (also referred to as radio communication networks), such as the Long Term Evolution (LTE), the LTE-Advanced (LTE-A) of the 3rd Generation Partnership Project (3GPP), or the predicted future 5G solutions, are typically composed of at least one network element, such as a network node 102, providing a cell 100. The cell 100 may be, e.g., a macro cell, a micro cell, femto, or a pico-cell, for example. The network node 102 may be an evolved Node B (eNB) as in the LTE and LTE-A, a radio network controller (RNC) as in the UMTS, a base station controller (BSC) as in the GSM/GERAN, or any other apparatus capable of controlling radio communication and managing radio resources within the cell 100. For 5G solutions, the implementation may be similar to LTE-A, as described above. The network node 102 may be a base station or an access node. The cellular communication system may be composed of a radio access network of network nodes similar to the network node 102, each controlling a respective cell or cells.

The network node 102 may be further connected via a core network interface to a core network 190 of the cellular communication system. In an embodiment, the core network 190 may be called Evolved Packet Core (EPC) according to the LTE terminology. The core network 190 may comprise a mobility management entity (MME) and a data routing network element. In the context of the LTE, the MME may track mobility of terminal devices 110, 120, and may carry out establishment of bearer services between the terminal devices 110, 120 and the core network 190. In the context of the LTE, the data routing network element may be called a System Architecture Evolution Gateway (SAE-GW). It may be configured to carry out packet routing to/from the terminal devices 110, 120 from/to other parts of the cellular communication system and to other systems or networks, e.g. the Internet.

The terminal devices 110, 120 may comprise, for example, cell phones, smart phones, tablets, and/or Machine Type Communication (MTC) devices, for example. There may be a plurality of terminal devices 110, 120 within the cell 100, and thus the network node 102 may provide service for more than two terminal devices. As shown in FIG. 1, the terminal devices may be in communication (i.e. transfer data and/or control information with the network) with the network node 102 using communication links 112, 122 respectively. These communication links 112, 122 may be referred to as conventional communication links in the cellular communication system. It is obvious for a skilled person that the conventional communication links may be used to transmit, for example, voice and packet data.

Further, the cellular communication system may support Device-to-Device (D2D) communication. This may mean that terminal devices, such as the terminal devices 110, 120, may be able to directly communicate with each other in the system. D2D communication link 114 between the terminal devices 110, 120 may enable data and/or configuration information transfer between the devices. Such may be beneficial, for example, in offloading the network. In one example, a first terminal device 110 has data to transmit to a second terminal device 120. If a D2D communication link is established or may be established between the two devices 110, 120, it may be beneficial to transmit that data directly using the D2D link. This may decrease the load of the network as the data does not need to be transmitted via the network node 102, for example.

Further, the system of FIG. 1 may comprise more terminal devices, such as a third and a fourth terminal devices 130, 140. These terminal devices may be similar to the first and second terminal device 110, 120. Thus, for example, there may be more than one terminal device pair, within a cell (e.g. cell 100), substantially simultaneously performing D2D communication.

The network node 102 may be more or less involved with the D2D communication in the example of FIG. 1. For example, the network node 102 may control at least partially the radio resources used for the communication by different terminal devices. However, in some cases the terminal devices 110, 120 may determine (e.g. self-schedule) radio resources for D2D communication. This may require that the network node 102 indicates a pool of radio resources from which one or more terminal devices may select the appropriate resources based on some criteria. However, it may also be possible that the terminal devices 110, 120 may be able to determine the radio resources independently in some cases using some predetermined criterion. For example, in MTC schema this may be beneficial as the number of devices may be so high that communication with the network node 102 may drastically increase the network load.

In a D2D enabled cellular communication network a direct communication between two terminal devices may happen if they are within certain distance from each other. This D2D direct communication may be under the control of the network node 102. For example, the network node 102 may control the distance or channel quality thresholds for performing the D2D communication. The network node 102 may assign time-frequency resources (i.e. radio resources) for the D2D direct connection establishment. Under favorable conditions, enabling D2D direct communication may provide higher data rates, lower latency, and/or better spectral efficiency. In some embodiments, a terminal device may have data to be sent to more than one terminal device (e.g. the first terminal device 110 may need to transmit data to the second and third terminal devices 120, 130).

A terminal device may also have data to be sent to the network node 102. Such data may comprise, for example, data for the network node 102 or data for another terminal device using the conventional communication link. In short, such data may be referred to as uplink data which may comprise data and/or control information. If the terminal device that is involved in D2D direct transmission has data to send to the network node 102 (e.g. an internet browsing session or a communication to another terminal device) then the terminal device may need to switch between D2D Direct Link to its D2D pair and Uplink to the network node 102. The Transmission Time Interval (TTI) and radio resources may need to be different for these two communication (i.e. D2D and uplink) to maintain orthogonality between the radio resources for avoiding or minimizing interference. This may limit the capacity of the system, and thus there may be a need for increasing the spectral efficiency by using the same resources for these two links. Further, also when a terminal needs to transmit data to two other terminal devices, the situation may be substantially similar. That is, spectral efficiency may also be an issue when two D2D links needs to be initiated. Therefore, there is provided a solution to enhance transmission of data by a terminal device. The solution may, for example, enhance D2D and uplink data transmission.

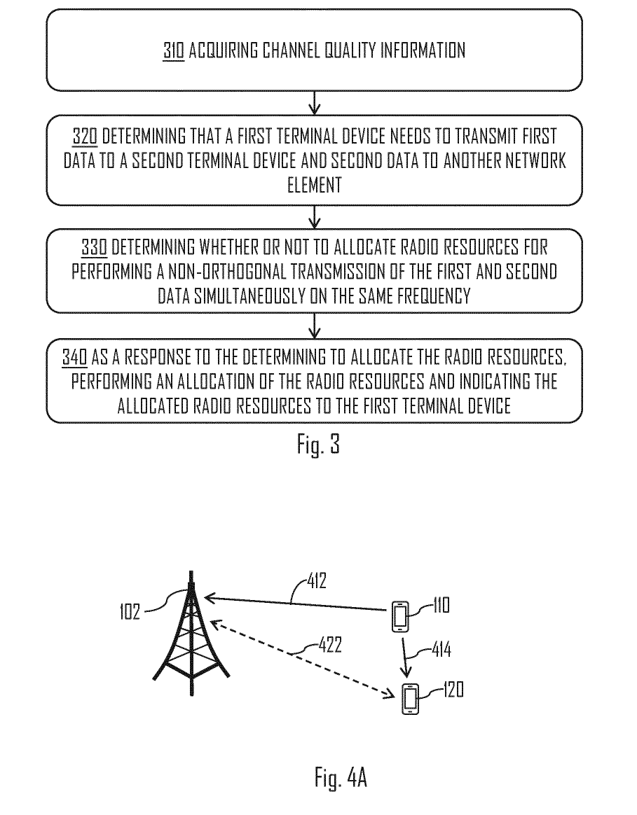

FIG. 2 illustrates a flow diagram according to an embodiment. Referring to FIG. 2, in step 210, a first terminal device of a radio communication network may determine a need to transmit first data to a second terminal device of the radio communication network and second data to another receiver of the radio communication network. In step 220, the first terminal device may acquire, from a network node of the radio communication network, radio resources for transmitting the first and the second data. In step 230, the first terminal device may perform a non-orthogonal transmission of the first and second data substantially simultaneously on the same frequency based on the acquired radio resources.

The first terminal device performing the steps 210 to 230 of FIG. 2 may be and/or be comprised in the terminal device(s) 110, 120. That is, the method may be performed by one of the terminal devices 110, 120 or a circuitry comprised in the terminal device, for example. For example, the first terminal device may be the terminal device 110 and the second terminal device may be the terminal device 120. The second terminal device may be the second terminal device 120, for example. In an embodiment, said another receiver referred to in step 210 of FIG. 2 is and/or comprises the network node (e.g. a base station, eNB). In an embodiment, said another receiver is and/or comprises a third terminal device (e.g. the third terminal device 130 or the fourth terminal device 140).

FIG. 3 illustrates a flow diagram according to an embodiment. Referring to FIG. 3, in step 310, a network node of a radio communication network may acquire channel quality information about quality of a radio channel between a first terminal device of the radio communication network and a second terminal device of the radio communication network and about quality of a radio channel between the first terminal device and another network element of the radio communication network. In step 320, the network node may determine that that the first terminal device needs to transmit first data to the second terminal device and second data to said another network element. In step 330, the network node may, as a response to the determining that the first terminal device needs to transmit the first and second data, determine, based at least on the channel quality information, whether or not to allocate, to the first terminal device, radio resources for performing a non-orthogonal transmission of the first and second data substantially simultaneously on the same frequency. In step 340, the network node may, as a response to determining to allocate the radio resources, perform an allocation of the radio resources and indicate the allocated radio resources to the first terminal device.

The network node performing the steps 310 to 340 of FIG. 3 may be and/or be comprised in the network node 102. That is, the method may be performed by the network node 102 and/or a part of the network node 102 (e.g. a circuitry of the network node 102), for example.

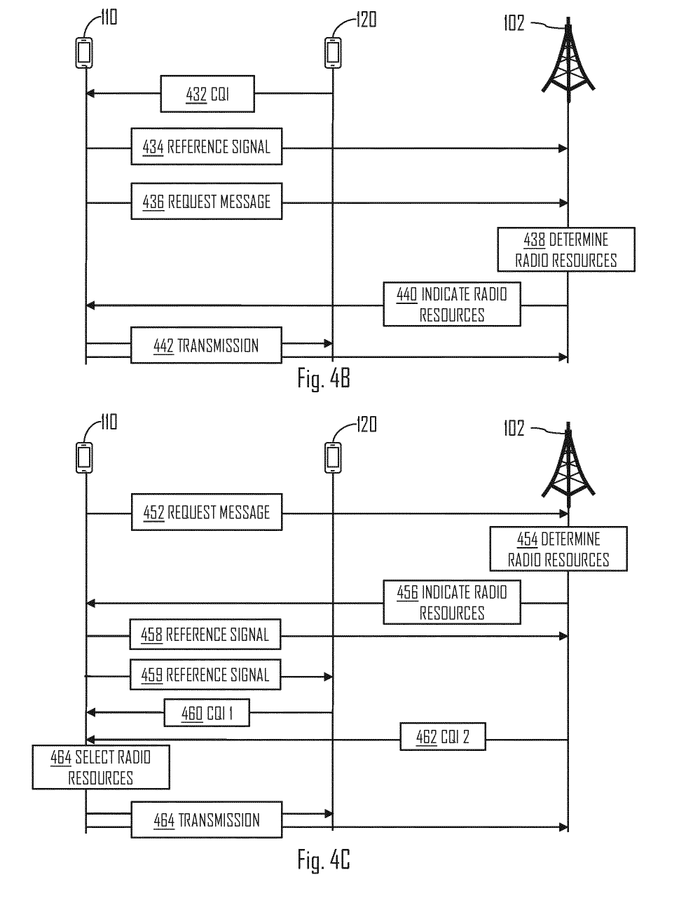

Let us now look a little bit closer on the embodiments. FIGS. 4A to 4C illustrate some embodiments. Referring to FIG. 4A, an arrow 412 may indicate uplink transmission from the first terminal device 110 to the network node 102, and an arrow 414 may indicate D2D transmission from the first terminal device 110 to the second terminal device 120. The non-orthogonal transmission of step 230 may comprise the D2D transmission and the uplink transmission. This may mean that the D2D and uplink transmissions are transmitted non-orthogonally substantially simultaneously using the same frequency. That is, the first data (i.e. D2D data) and second data (i.e. uplink data) may be transmitted substantially simultaneously using the same frequency, and further non-orthogonally. Thus, the transmission may use the same radio resources, i.e. the same time and frequency resources. In an embodiment, the transmissions of the first and second data are simultaneous.

The non-orthogonality may mean that the transmissions of the first and second data may interfere with each other. Compared with the orthogonal transmissions, where, for example, a suitable phase difference between the transmissions (or signals) may at least decrease interference, the non-orthogonal transmissions may interfere with each other. However, the receiver may be able to remove the interfering transmission, and may thus be able to receive the correct transmission. For example, if the second terminal device 120 receives the non-orthogonal transmission from the first terminal device 110, the second terminal device 120 may remove the transmission of the second data as interference, and thus be able to receive the first data (i.e. D2D data). Same may apply for the network node 102, wherein the network node 102 may be able to handle the transmission of the first data as interference. Therefore, it may be possible to transmit, by a terminal device at the same time using the same frequency, different data to another terminal device and to a network node. This may increase the efficiency of the network by enhancing the D2D and uplink data transmission in a case where a terminal device has data to be sent to both. In an embodiment, the first data and the second data are different compared with each other. In an embodiment, the first data and the second data differ at least partially from each other.

Referring to FIG. 4A, an arrow 422 may indicate path loss between the network node 102 and the second terminal device 120. In such case, for example, the network node 102 may transmit data to the second terminal device 120 via the first terminal device 110 utilizing the D2D communication. Thus, the D2D communication link between the terminal devices 110, 120 may established due to one or more reasons (e.g. first terminal device 110 and/or the second terminal device 120 needs to transmit data to the other). However, for example, when the first terminal device 110 determines that it needs to transmit the first and second data (D2D data and uplink data), it may also determine that there is already a D2D link established. This may be a further indication and/or a criterion for requesting the radio resources for the non-orthogonal transmission as described above.

In some embodiments, the non-orthogonal transmission of the first and second data substantially simultaneously on the same frequency refers to Non-Orthogonal Multiple Access (NOMA) transmission. In some embodiments, said transmission may be referred to as User Equipment (UE) or terminal device NOMA.

In embodiments of FIGS. 4B to 4C, it may be shown in detail how the interaction between different network elements may work. Referring first to FIG. 4B, the first terminal device 110 may receive channel quality information (CQI) transmitted by the second terminal device (block 432). CQI may indicate quality of a radio channel between network elements. In this case, for example, the CQI may indicate quality of a radio channel between the first and second terminal devices 110, 120. It may be possible that there are more than one radio channel established between the two, and thus the CQI may indicate quality of more than one radio channel. Similar logic applies to the radio channel(s) between the first terminal device 110 and the network node 102, for example.

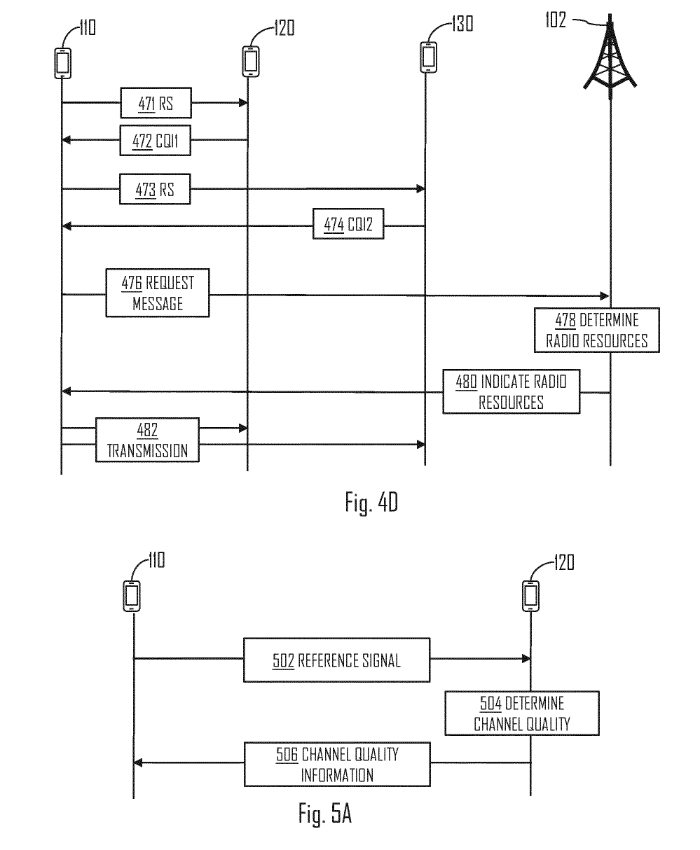

In an embodiment of FIG. 5A, one example of acquiring the CQI of the radio channel between the first and second terminal devices 110, 120 is given. Referring to FIG. 5A, the first terminal device 110 may transmit a reference signal to the second terminal device 120 (block 502). The second terminal device 120 may receive the reference signal, and determine the quality of the radio channel between the first and second terminal devices 110, 120 (block 504). This radio channel may be a D2D radio channel. The second terminal device 120 may then transmit the determined CQI (i.e. indicating the quality of the radio channel) to the first terminal device 110. The first terminal device 110 may receive the CQI from the second terminal device 120 (block 506).

In an embodiment, the first terminal device 110 transmits a reference signal to the second terminal device (block 502); and initiates a reception of a response to the transmitted reference signal, wherein the response comprises CQI about a radio channel between the first and the second terminal devices 110, 120. This may mean that the first terminal device 110 may not necessarily immediately receive the CQI information, but starts at least to expect the transmission of CQI from the second terminal device 120. At some point, when the second terminal device 120 decides to transmit the CQI, the first terminal device 110 may be able to receive the CQI.

Now referring again to FIG. 4B, in step 434, the first terminal device 110 may transmit a reference signal to the network node 102 for determination of quality of a radio channel between the first terminal device 110 and the network node 102. In an embodiment, the first terminal device 110 transmits another reference signal to the network node 102 for the determination of the quality of the radio channel between the first terminal device 110 and the network node 102.

In an embodiment, the first terminal device 110 transmits another reference signal to another network element (e.g. the third terminal device 130 or the network node 102) for the determination of the quality of the radio channel between the first terminal device 110 and said another network element.

Another reference signal may in this case mean that the first terminal device 110 may transmit a reference signal to the second terminal device 120 and another to the network node 102 or to the third terminal device 130, for example.

In an embodiment, the first terminal device 110 transmits the same reference signal to the second terminal device 120 and to the network node 102. This may save radio resources. Thus, for example, the reference signals transmitted in FIGS. 5A and 5B may be the same or different. Transmitting the same reference signal to two or more receivers may be referred to as broadcasting the reference signal. Thus, the broadcasting the reference signal may be targeted to a plurality of receivers. This may be beneficial, for example, if the first terminal device 110 first needs to perform transmission targeted to second terminal device 120 and the network node 102, and after that another transmission to another terminal device and the network node 102. Thus, for example, the first terminal device 110 may broadcast reference signal to a group of terminal devices and/or to the network node 102.

Referring to an embodiment of FIG. 5B, one example of transmitting the reference signal to the network node 102 may be shown. In block 512, the first terminal device 110 may transmit a reference signal to the network node 102. As explained, this transmission may be targeted to the network node 102 or both to the network node 102 and the second terminal device 120. The network node 102 may receive the reference signal from the first terminal device 110; and determine the quality of the radio channel between the network node and the first terminal device on the basis of the received reference signal (block 514). Thus, the network node 102 may become aware of the quality of the channel between the first terminal device 110 and the network node 102 (i.e. uplink channel). Block 516 of FIG. 5B may be discussed later in more detail. In short, in some embodiments, the network node 102 may indicate CQI about the radio channel between the first terminal device 110 and the network node 102 to the first terminal device 110. Thus, in some embodiments, the first terminal device 110 may acquire CQI about both the D2D and uplink channels. The CQI indicates to the first terminal device 110 the quality of the channel as detected by the receiver (i.e. by the second terminal device 120 and/or by the network node 102).

Let us yet again refer to FIG. 4B. The acquiring of CQI (block 432) and/or transmitting the reference signal (block 434) may happen also in different order or at least partially simultaneously. For example, a reference signal may first be transmitted to the network node 102 and then to the second terminal device 120, or, as described, only one reference signal may be used. The reference signals described above, e.g. in blocks 502, 512, may be, for example, Sounding Reference Signals (SRSs).

In block 436, the first terminal device 110 may transmit a request message to the network node 102, the request message requesting the radio resources for transmitting the first and second data. That is, after the first terminal device 110 determines the need to transmit the first and second data (i.e. D2D and uplink data) it may request radio resources for the transmission. The first terminal device 110 may, as a response to the transmitting the request message, acquire, from the network node 102, a radio resource message indicating the radio resources for transmitting the first and second data. Example of transfer of the radio resource message may be given in block 440, wherein the network node 102 may indicate the radio resources to the first terminal device 110.

The network node 102 may receive the request message, transmitted by the first terminal device in block 436, the request message requesting the radio resources for transmitting the first and second data. The network node 102 may determine, based at least partly on the received request message, that the first terminal device needs to transmit the first and second data is at least partially based on the received request message. Thus, the determination of block 320 of FIG. 3 may be based on the received request message. However, the determination may be based on some other indication also. For example, there may be a periodical uplink transmission and knowledge about ongoing D2D transmission. Thus, the network node 102 may determine the need based on those indications, but also from an explicit request message.

In an embodiment, the request message, transmitted by the first terminal device 110, comprises the CQI about the radio channel between the first and the second terminal devices 110, 120. Therefore, the network node 102 may acquire the CQI information about the D2D channel also. CQI information about the D2D channel and/or the uplink channel may be used in determination of radio resources for transmitting the first and/or second data.

Still referring to FIG. 4B, in block 438, the network node 102 may determine radio resources for transmitting, by the first terminal device 110, the first and/or second data. Thus, in block 438, the network node 102 may determine whether it allocates radio resources for the non-orthogonal transmission (e.g. NOMA) by the first terminal device 110. If the network node 102 determines to allocate said non-orthogonal transmission radio resources, the network node 102 may further determine the radio resources for the transmission. In block 440, the network node 102 may indicate the determined radio resources to the first terminal device 110 which may receive the indication about the radio resources.

In an embodiment of FIG. 4B, the network node 102 determines the exact radio resources to be used in the transmission of the first and second data. This may mean exact radio resources for the non-orthogonal transmission, or separate radio resources for transmitting the D2D data and uplink data. However, the exact radio resources here may mean that the network node 102 determines which radio resources are to be used for the transmission, and indicates said radio resources to the first terminal device 110. The radio resources may denote e.g. time and frequency resources.

The first terminal device 110 may, in block 442, use the indicated exact radio resources for transmitting the first and second data. For example, the indicated radio resources may be for the non-orthogonal transmission using substantially simultaneous radio resources on the same frequency. Thus, the first terminal device 110 may transmit the first and second data simultaneously to the second terminal device and the network node 102 (block 442). The receiver may disregard the data that is not intended for it as interference.

The first terminal device 110 may, before performing the transmission of block 442, perform a superposition coding of the first and second data using separate transmission power values for the first data and for the second data. Such coding may, for example, be part of NOMA technique. The receiver may decode the received data and obtain the information intended for it. Thus, the receiver may disregard the non-intended data (e.g. terminal device may disregard the uplink data).

Referring to the embodiment of FIG. 4C, the first terminal device 110 may transmit the request message to the network node 102 (block 452). In an embodiment, the request message transmitted in block 452 does not comprise the CQI about the channel between the first and second terminal devices 110, 120. In an embodiment, the request message transmitted in block 452 comprises the CQI about the channel between the first and second terminal devices 110, 120. The network node 102 may receive the request message and determine radio resources accordingly (block 454). In an embodiment, the network node 102 determines a radio resource pool comprising radio resources for the performing, by the first terminal device 110, the non-orthogonal transmission of the first and second data substantially simultaneously on the same frequency. This determination may be performed in block 454, for example. In block 456, the network node 102 may indicate the radio resource pool to the first terminal device 110 by transmitting a radio resource message to the first terminal device 110. The first terminal device 110 may receive the radio resource message and become aware about the radio resource pool.

The radio resources pool may be an alternative to the above-described indication about exact radio resources. The exact radio resource indication (e.g. in block 440) may comprise scheduling parameters for one TTI, for example. Thus, such allocation may be performed for each TTI separately, for example. In some cases the exact allocation may be for more than one TTI. In any case, the first terminal device 110 may use the radio resources which are allocated and indicated to it when the exact radio resource indication is used. However, using the radio resource pool, the network node 102 may indicate allocated radio resources from which the first terminal device 110 may select the radio resources to be used in the transmission. The radio resources pool indication using the radio resource message may comprise control period (e.g. for how many TTIs it is intended for, which may be, e.g. 40, 80, 160, or 360 TTIs), time-frequency resource configuration (e.g. number of Physical Resource Blocks (PRBs), starting PRB, and/or subframe bitmap (TTIs)), and/or transmission power parameter (e.g. transmission power for transmitting the first data and/or transmission power for transmitting the second data).

Still referring to FIG. 4C, the first terminal device 110 may perform the transmission of one or more reference signals in blocks 458, 459. As explained a reference signal may be transmitted simultaneously (e.g. same reference signal) to two or more receivers (e.g. network node 102 and the second terminal device 120). The second terminal device 120 may receive the one or more reference signals (e.g. transmitted in block 459). Thus, the first terminal device 110 may receive or acquire CQI about the D2D channel (block 460) (e.g. as a response to the transmitted reference signal to one or more receivers). The CQI about the D2D channel may be transmitted by the second terminal device 120. To be more precise such CQI may indicate how the second terminal device 120 sees the channel quality when signal is transmitted from the first terminal device to the second terminal device 120.

In an embodiment, the network node 102 determines to provide the radio resources for the non-orthogonal transmission (e.g. NOMA) if both the CQI1 and CQI2 indicate that the radio channels can be used to transmit data. Thus, the CQI for D2D channel and CQI for uplink channel may need to indicate that the channels can be used to transmit data. That is, such condition may be enough for the network node 102 to decide to provide the non-orthogonal resources. Similar logic may apply for the determination by the first terminal device 110.

In block 462, the first terminal device 110 may acquire the CQI about the channel between the first terminal device 110 and the network node 102. In an embodiment of FIG. 5C one example of acquiring the CQI by the first terminal device 110 and/or the network node 102 may be shown. Referring to FIG. 5C, the network node 102 may perform a downlink transmission to the first terminal device 110 (block 522). The first terminal device 110 may determine, based on the downlink transmission, channel quality of the channel between first terminal device 110 and the network node 102 (block 524). This may be estimation as the exact downlink channel quality may differ from the quality of the uplink channel. Thus, the estimation may be based on downlink channel quality and channel reciprocity, wherein the estimation is for the quality of the uplink channel. In an embodiment, but not necessarily, the first terminal device 110 further indicates the estimated channel quality to the network node 102 (block 516).

In an embodiment, the first terminal device estimates the quality of the radio channel between the first terminal device 110 and the network node 102 based on downlink channel estimation (block 524 of FIG. 5C), or receives, from the network node 102, an indication of the quality of the radio channel between the first terminal device 110 and the network node 102 (block 516 of FIG. 5B). In an embodiment, both the estimation and the indication are used. This may increase the accuracy of channel quality estimation.

In an embodiment, the first terminal device 110 estimates the quality of the radio channel between the first terminal device 110 and the second terminal device 120 based on a reference signal (e.g. SRS) transmitted by the second terminal device 120 to the first terminal device 110. In an embodiment, the first terminal device 110 indicates the CQI about the radio channel between the first terminal device 110 and the second terminal device 120 to the second terminal device 120. Thus, the second terminal device 120 may potentially perform or request similar radio resources for combined D2D and uplink transmission as the first terminal device 110 does, for example, as described in relation to FIG. 4B.

Referring to FIG. 4C, in block 464, the first terminal device 110 may select radio resources to be used in the transmission of the first and second data. The first terminal device 110 may select said radio resources from the radio resource pool indicated, in block 456, by the network node 102. Thus, the first terminal device 110 may first acquire radio resources comprising the radio resources pool (e.g. a set of radio resources), and then select at least a subset from the resource pool, wherein the subset may be used to transmit the first and second data orthogonally and at least substantially simultaneously on the same frequency. The transmission may be indicated in block 464.

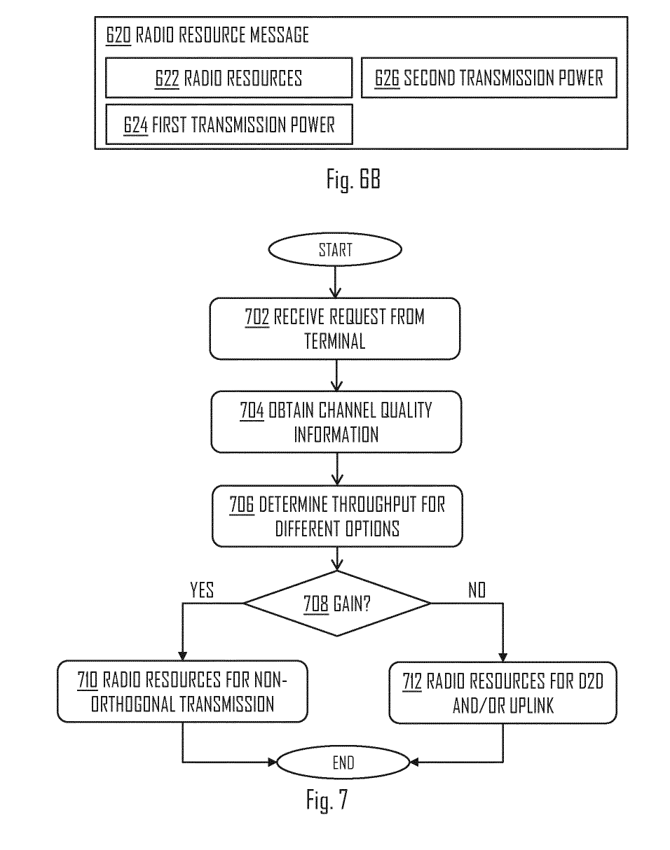

It further needs to be noted that in some embodiments, the first terminal device 110 may determine to perform a separate (e.g. orthogonal) transmission of the D2D and uplink data. For example, this determination may be based at least partly on the CQI1 and CQI2 received in blocks 460, 462. The determination may be similar to that of what is explained later, with reference to FIG. 7, about the determination by the network node 102. Specifically, reference is made to step 706 of FIG. 7.

In an embodiment, the selecting (e.g. in block 464) is at least partially based on radio resources used by other terminal devices applying D2D communication in the proximity of the first terminal device 110. That is, the resource pool, generated and indicated by the network node 102, may be for a plurality of terminal devices performing D2D transmissions (e.g. D2D NOMA). Thus, the first terminal device 110 should not use the resources which are used by other terminal devices in proximity. This may be avoided by applying communication between terminal devices, for example. On the other hand, the network node 102 may indicate the resources pool such that the first terminal device 110 may select only resources that are meant for the first terminal device 110. E.g. resource pool indication may comprise only radio resources meant for the first terminal device 110.

In an embodiment, the selecting (e.g. in block 464) is based on radio resources used by other terminal devices applying device-to-device communication in the proximity of the first terminal device, quality of the radio channel between the first terminal device 110 and the network node 102, the channel quality information about the radio channel between the first and the second terminal devices 110, 120, and/or the channel quality information about the radio channel between the first and the third terminal devices 110, 130 (explained later with reference to FIG. 4D). For example, the first terminal device 110 may estimate the PRBs and transmission powers for simultaneous transmission using NOMA to the second terminal device 120 and to the network node 102. For this estimation the first terminal device 110 may utilize the CQIs from both channels (i.e. D2D and uplink channel). For example, if the first terminal device 110 transmits data to second and third terminal device 120, 130, CQIs acquired from the second and third terminal device 120, 130 may needed. On the other hand, the first terminal device 110 may also acquire said CQIs by, for example, estimating the channel quality based on some transmissions from the second and third terminal device 120, 130. Still referring to FIG. 4C, in some embodiments the first terminal device 110 schedules, based on the indicated radio resources in block 456 (e.g. resource pool), radio resources for the transmission of the first and second data (e.g. NOMA transmission). The scheduling may comprise scheduling resources for the transmitting. The scheduling may comprise scheduling resources for the second terminal device 120 for receiving the first data (i.e. D2D data). The first terminal device 110 may transmit a message indicating the necessary resources to the second terminal device 120. The scheduling may comprise indicating the scheduled resources to the network node 102 so that also the network node 102 may become aware on which resources the transmission will be performed.

In an embodiment, the network node 102 schedules the second terminal device 120 for receiving the transmission performed by the first terminal device 110. That is, if the network node 102, for example, indicated explicit radio resources for transmitting, by the first network node 110, the first and second data, the network node 102 may also indicate, directly and/or via the first terminal device 110, to the second terminal device 120 the radio resources on which the transmission is performed. Thus, the second terminal device 120 may know on which resources the data is to be expected.

Let us now look at an embodiment of FIG. 4D. The embodiment of FIG. 4 may relate to the situation described above, where the first terminal device 110 needs to transmit data to the second and the third terminal device 120, 130. Before or after determining the need to transmit the first data (e.g. first D2D data) and the second data (e.g. second D2D data), the first terminal device 110 may transmit one or more reference signals to the second and third terminal devices 120, 130 (blocks 471, 473). As described above, a single reference signal may be transmitted to a plurality of receivers. That is, for example, the first terminal device 110 may transmit one reference signal to the second terminal device 120, the third terminal device 130, and/or to the network node 102. In some embodiments, the first terminal device 110 transmits one reference signal to the second terminal device 120 and to the third terminal device 130. In some embodiments, the first terminal device 110 transmits different reference signals to the second terminal device 120 and to the third terminal device 130 as indicated in FIG. 4D.

In blocks 472, 474, the second and third terminal devices 120, 130 may indicate CQIs of the radio channels based on the received reference signals. I.e. the second terminal device 120 may indicate CQI about a radio channel between the first and second terminal devices 110, 120 (block 472). The third terminal device 130 may indicate CQI about a radio channel between the first and third terminal devices 110, 130 (block 474). The first terminal device 110 may receive said CQIs.

As the first terminal device 110 has determined the need to transmit data to the second terminal device 120 and data to the third terminal device 130, the first terminal device 110 may, in block 476, transmit the request message to the network node 102. That is, the first terminal device 110 may request radio resources for performing a non-orthogonal transmission (e.g. NOMA) to the second and third terminal devices 120, 130. The network node 102 may determine the radio resources based on the request message (block 478). In block 480, the network node 102 may indicate the radio resources to the first terminal device 110. Blocks 478 and 480 are well discussed above, and may comprise indicating specific radio resources or radio resource pool, for example.

In an embodiment, the request message comprises CQI about the radio channel between the first terminal device 110 and the second terminal device 120 and/or CQI about the radio channel between the first terminal device 110 and the third terminal device 130.

In block 482, the first terminal device 110 may perform the non-orthogonal transmission on at least some of the radio resources indicated in block 480 by the network node 102. The performed transmission may be to the second and to the third terminal devices 120, 130 substantially or totally simultaneously using the same frequency.

It needs to be noted that the situation may be rather similar to that of explained with reference to FIGS. 4A to 4C, for example. That is, the main difference may be that instead of having a need to transmit both D2D and uplink data (e.g. to the second terminal device 120 and to the network node 102, the first terminal device 110 may have a need to transmits only D2D data (i.e. no need to transmit uplink data), but to two different terminal devices. The data transmitted to the second terminal device 120 (e.g. first data or first D2D data) and the data transmitted to the third terminal device 130 (e.g. second data or second D2D data) may be different to each other. However, the network node 102 may still provide resources for transmitting the first and second D2D data.

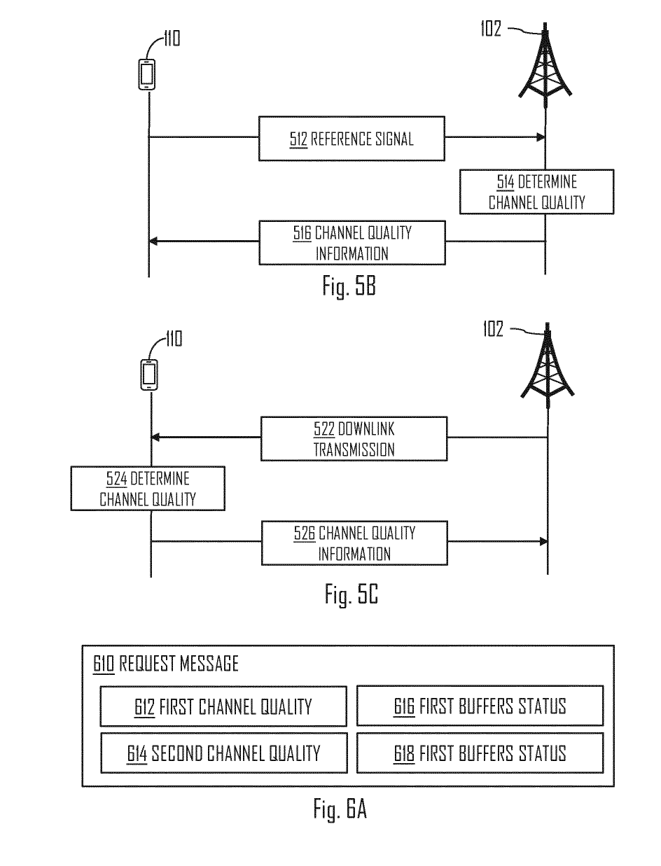

FIGS. 6A to 6B illustrate some embodiments. Referring to FIG. 6A, a request message 610, such as the request message transmitted in block 436 of FIG. 4B and/or the request message transmitted in block 452 of FIG. 4C, is shown. The request message 610 may comprise, depending on the situation, first channel quality information 612 (e.g. channel quality between the first terminal device 110 and the second terminal device 120), second channel quality information 614 (e.g. channel quality between the first terminal device 110 and the network node 102 or channel quality between the first terminal device 110 and the third terminal device 130), first buffer status 616 (e.g. data amount to be transmitted to the second terminal device 110), and/or second buffer status 618 (e.g. data amount to be transmitted to the network node 102 or to the third terminal device 130).

In an embodiment, determination by the network node 102 whether to allocate the non-orthogonal radio resources is further based on the buffer statuses 616, 618. That is, if there is enough data that needs to be transmitted by the first terminal device 110, the network node 102 may decide to provide the radio resources for the non-orthogonal transmission, provided also that the CQIs indicate channel qualities that fulfill channel quality requirements.

Referring to FIG. 6B, a radio resource message 620 is shown. Such message may be transmitted, by the network node 102 to the first terminal device 110, to indicate the radio resources for transmitting the first and second data. In an embodiment, the radio resource message indicates the explicit resources for the transmission. In an embodiment, the radio resources message indicates the radio resource pool. As described above, the radio resource message 620 may comprise, for example, control period, time-frequency resources (e.g. number of PRBs, start PRB, subframe-bitmap), and/or transmission power parameter 624, 626. In more general terms, the radio resource message 620 may comprise the radio resources 622 (e.g. indicating specific PRBs, resource elements, or a pool of PRBs). Further, power parameters 624, 626 may also be indicated.

In an embodiment, the radio resource message 620 is referred to as NOMA grant, NOMA radio resource message, or D2D NOMA radio resource message. It may also be that NOMA resource pool indication-term is used.

In an embodiment, the request message 620 is referred to as NOMA request, NOMA request message, or D2D NOMA request message.

In an embodiment, the network node 102 indicates a transmission power for transmitting the first data and a transmission power for transmitting the second data, wherein the transmission powers are unequal compared with each other. For example, the radio resource message 620 may be used to indicate the transmission powers. The first data may refer to, for example, data transmitted to the second terminal device 120. The second data may refer to, for example, data transmitted to the third terminal device 130 or to the network node 102.

In an embodiment, the first terminal device determines, based on an indication from the network node 102, the first transmission power for transmitting the first data and the second transmission power for transmitting the second data. The first transmission power and the second transmission power may be unequal compared with each other. In an embodiment, the first terminal device 110 determines the transmission powers using predefined information. For example, the terminal device 110 may comprise information indicating the transmission powers in different scenarios.

In an embodiment, the network node indicate (e.g. with the radio resource message 620) the transmission powers for transmitting the first and second data. However, the first terminal device 110 may select which of the indicated transmission powers it uses in transmitting the first data and which it uses for transmitting the second data. In an embodiment, the network node 102 indicates specifically which transmission power is to be used in transmitting the first data and which transmission power is to be used in transmitting the second data.

Referring to FIG. 4A, for example, the first data 414 (i.e. D2D data) may be transmitted with the first transmission power, and the second data (i.e. uplink data) may be transmitted with the second transmission power. It needs to be reminded that the transmission performed, for example in step 230, comprises both the first and second data. Thus, both receivers may detect the same transmission, but disregard the data that is not intended for the particular receiver. One possibility is to the power multiplexing, e.g. transmitting the first and second data with different powers.

In an embodiment, the first terminal device 110 indicates the first and/or second transmission power to the second terminal device 120.

In an embodiment, the first terminal device 110 determines the first and/or second transmission power based on configuration information. For example, the configuration information may be preinstalled to the terminal device and/or it may be cell-specific. As described, it may also be possible to receive the power parameters from the network (e.g. from the network node 102).

In an embodiment, the first transmission power is lower compared with the second transmission power. In an embodiment, the second transmission power is lower compared with the first transmission power. The difference between the two powers may be such that the receiver may be able to separate the two transmission from each other. For example, 6 Decibel-milliwatt (dBm) or higher difference between the first and second transmission powers may be beneficial.

FIG. 7 illustrates a flow diagram according to an embodiment. Referring to FIG. 702, the network node 102 may receive a request (e.g. radio resource request for NOMA) from the first terminal device 110 (step 702). The network node 704 may obtain CQI information about the D2D and uplink channels (step 704). Different options on how to acquire CQI information are discussed in detail above. Also, in some embodiment, the network node may obtain CQI about two D2D radio channels between three terminal devices, as explained, for example, with reference to FIG. 4D.

In step 706, the network node 102 may determine data throughput for different options. This may mean that the network node 102 determines which kind of resource allocation would benefit the overall performance of the network, for example. For example, the network node 102 may determine whether it is beneficial to give resources for the non-orthogonal transmission (i.e. first and second data in the same frequency simultaneously) or would it be better to give resources for D2D transmission and/or for uplink transmission (or in some cases to two orthogonal D2D transmissions). That is, if the network node 102 estimates (in block 708) that the throughput gain is positive using the non-orthogonal transmission, the method may proceed to step 710. Otherwise, it may proceed to step 712. In step 712, separate radio resources may be given to D2D and/or to uplink transmissions. In some embodiments of step 712, separate radio resources may be given to two D2D transmissions, wherein one may be for transmitting data to the second terminal device 120 and another may be for transmitting another data to the third terminal device 130.

In step 710, the network node 102 may allocate and/or indicate the radio resources for the non-orthogonal transmission (e.g. NOMA). Such transmission may comprise, for example, D2D and uplink data, or first D2D data and second D2D data.

In an embodiment, as a response to determining not to allocate the radio resources for transmitting the first and second data substantially simultaneously on the same frequency, the network node 102 allocates, to the first terminal device 110, device-to-device radio resources for transmitting the first data to the second terminal device 120 and uplink radio resources for transmitting the second data to the network node 102 (step 712).

In an embodiment, as a response to determining not to allocate the radio resources for transmitting the first and second data substantially simultaneously on the same frequency, the network node 102 allocates, to the first terminal device 110, D2D radio resources for transmitting the first data to the second terminal device 120 and D2D resources for transmitting the second data to the third terminal device 130 (step 712).

Let us now go through one example of the determination about the throughput gain in one example scenario with reference to FIG. 4A. The first terminal device 110 is referred simply as UE1 and the second terminal device 120 simply as UE2. Also, the network node 102 in this specific example is eNB. However, it may also be some other kind of base station or network node, for example.

Referring to FIG. 4A, let us assume UE1 has data to send to UE2 and also has data to send to eNB. A possible scenario may be UE1 has some huge file like video to be transmitted to UE2, when at the same time uploading some other file to the Internet (e.g. uplink to eNB). Since UE1 and UE2 are close to each other, a direct D2D link may be formed between these two UEs and the eNB can offload the traffic for UE2 via the D2D direct link. In this case the UE1 needs to transmit data x_{ENB} (e.g. second data) intended for eNB using a cellular uplink connection and transmit data x_{UE2} (e.g. first data) using a direct D2D connection. Since eNB controls both of these links (in this specific example), it needs to schedule time and frequency resources such that the data is being transferred in a fair manner on both the links. Further let us assume the UE1 is a located at cell-edge area or otherwise has bad RF conditions. In a cellular network, it may be possible that about 5% of the UEs will fall under this category because of various reasons like they may be under a shadow region or comparatively at a larger distance from eNB. Typically the cell edge UE path loss in the uplink may have values such as 100 dB to 130 dB.

The D2D link may be formed between two UEs when they are relatively close to each other. The proximity of the devices may be a criteria for the formation of D2D link and because of that the path loss between two D2D linked UEs is relatively low, typically having values of about 80 dB to 95 dB. Taking 110 dB as the path loss between the eNB and the UE1 and 90 dB as the path loss between UE1 and UE2, we can get an estimate of throughput for both links as given below.

Continuing the same example, if we assume the UE1 is transmitting with its maximum transmit power (23 dBm) the maximum throughput for an Additive White Gaussian Noise (AWGN) channel is given by the Shannon's equation Eq.1:

Throughput=BW*log₂(1+SINR).

BW is the allocated bandwidth for the link and SINR is the signal to interference plus noise ratio seen at the receiver. SINR is given by the equation below, assuming external interference is zero:

SINR=transmit power*path gain/Noise power.

SINR at the eNB, SINR_{eNB}=23+(−1*110)−(−99)=12 dB, here, −99 dB is the noise power at eNB assuming a noise floor of 5 dB for eNB at room temperature and with 2 GHz carrier frequency.

SINR at UE2, SINR_{UE2}=23−95−(−95)=23 dB, assuming 9 dB noise floor for the receiver UE.

The throughput expected at eNB from equation (1), R_{eNB}=2.8 bits/sec/Hz. The throughput expected at UE2 from the D2D direct link, R_{UE2}=5.3 bits/sec/Hz.

Now instead of scheduling separate TTIs for uplink and for the D2D link with different resource blocks, for example, NOMA can be used to schedule both links at the same TTI using same Resource Blocks (RBs), as explained in more general terms above.

Still continuing the example, according to NOMA technique, the expected throughputs at UE2 and eNB are given below:

$${R}_{UE 2} = {log}_{2} [ 1 + \frac{{P}_{UE 2} {G}_{UE 2}}{{N}_{0 , UE 2}} ]$$

$${R}_{eNB} = {log}_{2} [ 1 + \frac{{P}_{eNB} {G}_{eNB}}{{P}_{UE 2} {G}_{eNB} + {N}_{0 , eNB}} ]$$

Where, P_{UE2} and P_{eNB} are the power allocated to data, x_{UE2} for UE2 and x_{eNB} for eNB respectively before superposition coding by UE1. G_{UE2} and G_{eNB} are path gain from UE1 to UE2 and eNB respectively. Path gain is the inverse of path loss and is −95 dB and −110 dB respectively for UE2 and eNB in this example. N_{0,UE2} and N_{0,eNB} are thermal noise at receivers of UE2 and eNB respectively.

For example, where the transmission power allocated for transmitting the data for UE2 is 15 dBm, the remaining power of the total 23 dBm is allocated for the transmission of the data to the eNB. This value is calculated by subtracting after converting the power values to linear values in milliWatts. This equals to 22.25 dBm, for the eNB transmission, as the power allocation for the data part of the signal sent to eNB. The ratio P_{eNB}/P_{UE2}=5.3, in this example.

Since data for eNB is at a higher power it comes first in the decoding order. So, the eNB does not need to do SIC (successive interference cancellation) to get the data. UE2 however may first decode the data intended for eNB and then use SIC to cancel that as interference, and further derives its own data from the transmission.

Thus with power allocation of 15 dBm for the UE2 data and 22.25 dBm for the eNB data we have 3.485 bits/sec/Hz rate for UE2 and 1.568 bits/sec/Hz rate for eNB using same PRB and at the same TTI. This can be compared, by the eNB, with the throughput without using NOMA 5.3 bits/sec/Hz for UE2 and 2.8 bits/sec/Hz for eNB at different TTIs. So, the average per TTI value of throughputs are 2.7 bits/sec/Hz and 1.4 bits/sec/Hz for UE2 and eNB respectively without using NOMA. The gain in throughput using NOMA in this example is around 30%. Therefore, the eNB would, in step 708 of FIG. 7, determine to use the non-orthogonal transmission. More particularly, in this example NOMA would we performed by the first terminal device 110.

In an embodiment, the first terminal device 110 performs the steps 704, 706, 708 of FIG. 7. Further, based on the determination on step 708, the first terminal device 110 may perform the step 710 or the step 712. This may apply for a case, for example, where the first terminal device 110 selects or schedules radio resources (e.g. from the radio resource pool) for transmitting the first and second data.

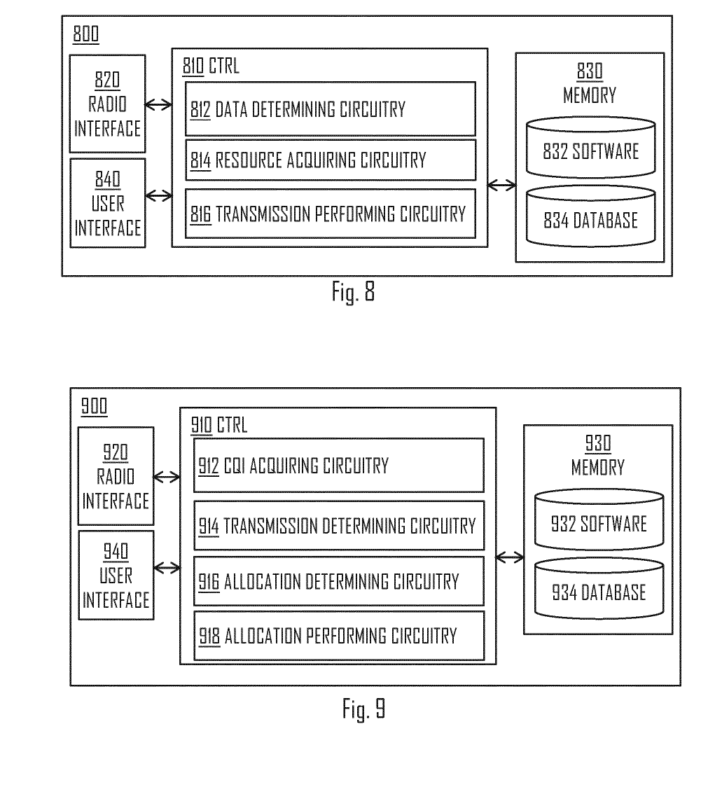

FIGS. 8 to 9 provide apparatuses 800, 900 comprising a control circuitry (CTRL) 810, 910, such as at least one processor, and at least one memory 830, 930 including a computer program code (software) 832, 932, wherein the at least one memory and the computer program code (software) 832, 932, are configured, with the at least one processor, to cause the respective apparatus 800, 900 to carry out any one of the embodiments of FIGS. 2 to 7, or operations thereof.

Referring to FIGS. 8 to 9, the memory 830, 930, may be implemented using any suitable data storage technology, such as semiconductor based memory devices, flash memory, magnetic memory devices and systems, optical memory devices and systems, fixed memory and removable memory. The memory 830, 930 may comprise a database 834, 934 for storing data.

The apparatuses 800, 900 may further comprise radio interface (TRX) 820, 920 comprising hardware and/or software for realizing communication connectivity according to one or more communication protocols. The TRX may provide the apparatus with communication capabilities to access the radio access network, for example. The TRX may comprise standard well-known components such as an amplifier, filter, frequency-converter, (de)modulator, and encoder/decoder circuitries and one or more antennas. For example, the TRX may enable communication between the first terminal device 110 and the network node 102 and/or the D2D communication capability. Further, the TRX may provide access to the X2-interface for the network node 102, for example.

The apparatuses 800, 900 may comprise user interface 840, 940 comprising, for example, at least one keypad, a microphone, a touch display, a display, a speaker, etc. The user interface 840, 940 may be used to control the respective apparatus by a user of the apparatus 800, 900. For example, a network node may be configured using the user interface comprised in said network node. Naturally, a terminal device may comprise a user interface.

In an embodiment, the apparatus 800 may be or be comprised in a terminal device, such as a mobile phone or cellular phone, for example. The apparatus 800 may be the first terminal device 110, for example. In an embodiment, the apparatus 800 is comprised in the terminal device 110 or in some other terminal device. Further, the apparatus 800 may be the first terminal device performing the steps of FIG. 2, for example.

Referring to FIG. 8, the control circuitry 810 may comprise a data determining circuitry 812 configured to determine a need to transmit first data to a second terminal device of a radio communication network and second data to another receiver of the radio communication network; a resource acquiring circuitry 814 configured to acquire, from a network node of the radio communication network, radio resources for transmitting the first and the second data; and a transmission performing circuitry 816 configured to perform a non-orthogonal transmission of the first and second data substantially simultaneously on the same frequency based on the acquired radio resources.

In an embodiment, the apparatus 900 may be or be comprised in a base station (also called a base transceiver station, a Node B, a radio network controller, or an evolved Node B, for example). The apparatus 900 may be the network node 102, for example. Further, the apparatus 900 may be the network node performing the steps of FIG. 3. In an embodiment, the apparatus 900 is comprised in the network node 102.

Referring to FIG. 9, the control circuitry 910 comprises a CQI acquiring circuitry 912 configured to acquire channel quality information about quality of a radio channel between a first terminal device of a radio communication network and a second terminal device of the radio communication network and about quality of a radio channel between the first terminal device and another network element of the radio communication network; a transmission determining circuitry 914 configured to determine that the first terminal device needs to transmit first data to the second terminal device and second data to said another network element; an allocation determining circuitry 916 configured to, as a response to the determining that the first terminal device needs to transmit the first and second data, determine, based at least on the channel quality information, whether or not to allocate, to the first terminal device, radio resources for performing a non-orthogonal transmission of the first and second data substantially simultaneously on the same frequency; and an allocation performing circuitry 918 configured to, as a response to determining to allocate the radio resources, perform an allocation of the radio resources and indicate the allocated radio resources to the first terminal device.

In an embodiment of FIG. 9, at least some of the functionalities of the apparatus 900 (e.g. the network node 102) may be shared between two physically separate devices, forming one operational entity. Therefore, the apparatus may be considered to depict the operational entity comprising one or more physically separate devices for executing at least some of the above-described processes. Thus, the apparatus of FIG. 9, utilizing such a shared architecture, may comprise a remote control unit (RCU), such as a host computer or a server computer, operatively coupled (e.g. via a wireless or wired network) to a remote radio head (RRH) located at a base station site. In an embodiment, at least some of the described processes of the network node may be performed by the RCU. In an embodiment, the execution of at least some of the described processes may be shared among the RRH and the RCU. In such a context, the RCU may comprise the components illustrated in FIG. 9, and the radio interface 920 may provide the RCU with the connection to the RRH. The RRH may then comprise radio frequency signal processing circuitries and antennas, for example.

In an embodiment, the RCU may generate a virtual network through which the RCU communicates with the RRH. In general, virtual networking may involve a process of combining hardware and software network resources and network functionality into a single, software-based administrative entity, a virtual network. Network virtualization may involve platform virtualization, often combined with resource virtualization. Network virtualization may be categorized as external virtual networking which combines many networks, or parts of networks, into the server computer or the host computer (i.e. to the RCU). External network virtualization is targeted to optimized network sharing. Another category is internal virtual networking which provides network-like functionality to the software containers on a single system. Virtual networking may also be used for testing the terminal device.

In an embodiment, the virtual network may provide flexible distribution of operations between the RRH and the RCU. In practice, any digital signal processing task may be performed in either the RRH or the RCU and the boundary where the responsibility is shifted between the RRH and the RCU may be selected according to implementation.

As used in this application, the term ‘circuitry’ refers to all of the following: (a) hardware-only circuit implementations, such as implementations in only analog and/or digital circuitry, and (b) combinations of circuits and soft-ware (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

In an embodiment, at least some of the processes described in connection with FIGS. 2 to 7 may be carried out by an apparatus comprising corresponding means for carrying out at least some of the described processes. Some example means for carrying out the processes may include at least one of the following: detector, processor (including dual-core and multiple-core processors), digital signal processor, controller, receiver, transmitter, encoder, decoder, memory, RAM, ROM, software, firmware, display, user interface, display circuitry, user interface circuitry, user interface software, display software, circuit, antenna, antenna circuitry, and circuitry. In an embodiment, the at least one processor, the memory, and the computer program code form processing means or comprises one or more computer program code portions for carrying out one or more operations according to any one of the embodiments of FIGS. 2 to 7 or operations thereof.

According to yet another embodiment, the apparatus carrying out the embodiments comprises a circuitry including at least one processor and at least one memory including computer program code. When activated, the circuitry causes the apparatus to perform at least some of the functionalities according to any one of the embodiments of FIGS. 2 to 7, or operations thereof.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments as described may also be carried out in the form of a computer process defined by a computer program or portions thereof. Embodiments of the methods described in connection with FIGS. 2 to 7 may be carried out by executing at least one portion of a computer program comprising corresponding instructions. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium. Coding of software for carrying out the embodiments as shown and described is well within the scope of a person of ordinary skill in the art. In an embodiment, a computer-readable medium comprises said computer program.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. A method comprising:
determining, by a first terminal device of a radio communication network, a need to transmit first data to a second terminal device of the radio communication network and second data to another receiver of the radio communication network;
acquiring, from a network node of the radio communication network, radio resources for transmitting the first and the second data; and
performing a non-orthogonal transmission of the first and second data substantially simultaneously on the same frequency based on the acquired radio resources.

2. The method of claim 1, further comprising:
determining, based on an indication from the network node, a first transmission power for transmitting the first data and a second transmission power for transmitting the second data, wherein the first transmission power and the second transmission power are unequal compared with each other.

3. The method of claim 1, further comprising:
transmitting a reference signal to the second terminal device; and
initiating a reception of a response to the transmitted reference signal, wherein the response comprises channel quality information about a radio channel between the first and the second terminal devices.

4. The method of claim 1, further comprises:
transmitting another reference signal to said another receiver for determination of quality of a radio channel between the first terminal device and said another receiver.

5. The method of claim 1, further comprising:
transmitting a request message to the network node, the request message requesting the radio resources for transmitting the first and second data; and
as a response to the transmitting the request message, acquiring, from the network node, a radio resource message indicating the radio resources for transmitting the first and second data.

6. The method of claim 5, wherein the request message comprises the channel quality information about the radio channel between the first and the second terminal devices and/or channel quality information about the radio channel between the first terminal device and said another receiver.

7. The method of claim 1, wherein the acquired radio resources comprise a radio resource pool, the method further comprising:
selecting, from the radio resource pool, radio resources to be used in the transmission of the first and second data.

8. The method of claim 1, wherein said another receiver comprises a third terminal device.

9. The method of claim 1, wherein said another receiver comprises the network node.

10. The method of claim 9, further comprising:
estimating the quality of a radio channel between the first terminal device and the network node based on downlink channel estimation, or
receiving, from the network node, an indication of the quality of the radio channel between the first terminal device and the network node.

11. The method of claim 7, wherein the selecting is based on radio resources used by other terminal devices applying device-to-device communication in the proximity of the first terminal device, quality of the radio channel between the first terminal device and the network node, the channel quality information about the radio channel between the first and second terminal devices, and/or the channel quality information about the radio channel between the first and third terminal devices.

12. A method comprising:
acquiring, by a network node of a radio communication network, channel quality information about quality of a radio channel between a first terminal device of the radio communication network and a second terminal device of the radio communication network and about quality of a radio channel between the first terminal device and another network element of the radio communication network;
determining that the first terminal device needs to transmit first data to the second terminal device and second data to said another network element;
as a response to the determining that the first terminal device needs to transmit the first and second data, determining, based at least on the channel quality information, whether or not to allocate, to the first terminal device, radio resources for performing a non-orthogonal transmission of the first and second data substantially simultaneously on the same frequency; and
as a response to determining to allocate the radio resources, performing an allocation of the radio resources and indicating the allocated radio resources to the first terminal device.

13. The method of claim 12, further comprising:
receiving a request message from the first terminal device, the request message requesting the radio resources for transmitting the first and second data, wherein the determination that the first terminal device needs to transmit the first and second data is at least partially based on the received request message.

14. (canceled)

15. The method of claim 12, wherein said another network element comprises the network node or a third terminal device.

16. The method of claim 15, wherein said another network element comprises the network node, the method further comprising:
receiving a reference signal from the first terminal device; and
determining the quality of the radio channel between the network node and the first terminal device on the basis of the received reference signal.

17. The method of claim 12, further comprising:
determining a radio resource pool comprising radio resources for the performing, by the first terminal device, the non-orthogonal transmission of the first and second data substantially simultaneously on the same frequency; and
indicating the radio resource pool to the first terminal device by transmitting a radio resource message to the first terminal device.

18. The method of claim 12, wherein the network node indicates a transmission power for transmitting the first data and a transmission power for transmitting the second data, wherein the transmission powers are unequal compared with each other.

19. An apparatus comprising:
at least one processor, and
at least one memory comprising a computer program code, wherein the at least one memory and the computer program code are configured, with the at least one processor, to cause a first terminal device of a radio communication network to:
determine a need to transmit first data to a second terminal device of the radio communication network and second data to another receiver of the radio communication network;
acquire, from a network node of the radio communication network, radio resources for transmitting the first and the second data; and
perform a non-orthogonal transmission of the first and second data substantially simultaneously on the same frequency based on the acquired radio resources.

20-38. (canceled)

39. A computer program product, the computer program product being tangibly embodied on a non-transitory computer-readable storage medium and including instructions that, when executed by at least one processor, are configured to perform the method of claim 1.

40. A computer program product, the computer program product being tangibly embodied on a non-transitory computer-readable storage medium and including instructions that, when executed by at least one processor, are configured to perform the method of claim 12.
